(19) United States
(12) Patent Application Publication
(10) Pub. No.: US 2009/0016791 A1
(43) Pub. Date: Jan. 15, 2009

(54) FUSING DEVICE AND IMAGE FORMING APPARATUS HAVING THE SAME

(75) Inventor: Jong-oh KIM, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/119,668

(22) Filed: May 13, 2008

(30) Foreign Application Priority Data
Jul. 9, 2007 (KR) 10-2007-0068574

(51) Int. Cl. G03G 15/20

(52) U.S. Cl. 399/331

(57) ABSTRACT

A fusing device fuses an image on a printing medium, and includes a belt which is provided to rotate; a heating plate which is supported to an inner surface of the belt, a pressing roller which presses the printing medium against the heating plate, and a piezoelectric member which is disposed to the heating plate and presses at least one portion of the heating plate with respect to the pressing roller if power is applied thereto.

### CROSS-REFERENCE TO RELATED APPLICATIONS

This application claims priority under 35 U.S.C. §119(a) from Korean Patent Application No. 10-2007-0068574, filed on Jul. 9, 2007 in the Korean Intellectual Property Office, the disclosure of which is incorporated herein by reference in its entirety.

### BACKGROUND OF THE INVENTION

1. Field of the Invention

The present general inventive concept relates to a fusing device and an image forming apparatus. The present general inventive concept relates to minimizing inequality of a pressure distribution applied to a fusing nip area in a fusing device.

2. Description of the Related Art

An image forming apparatus forms a visible image by means of a developer on a printing medium, and fuses the visible image being not fused yet on the printing medium by applying heat and pressure to the visible image by means of a fusing device. The fusing device includes a heating unit emitting the heat, and a pressing roller rotating to press against the heating unit to form a fusing nip. The printing medium passes through the fusing nip area to which the heat and the pressure are applied so that fusing can be accomplished.

However, in the fusing device, opposite end parts of the pressing roller are pressed by an elastic member such as a coil spring, etc. Here, a minute bending phenomenon is caused due to a self weight of the pressing roller in a central portion in a lengthwise direction of the pressing roller, thereby causing a pressure decrease in the fusing nip of this central portion.

The pressure applied to the central portion of the pressing roller decreases the width of the fusing nip contacting with the printing medium, and the amount of heat transmitted to the developer on the printing medium. Accordingly, a fusing property of the developer is deteriorated, and an image inferiority on the printing medium is caused.

### SUMMARY OF THE INVENTION

The present general inventive concept provides a fusing device and an image forming apparatus having the same to minimize an unequal distribution of a pressure applied to a fusing nip.

Additional aspects of the present general inventive concept will be set forth in part in the description which follows and, in part, will be obvious from the description, or may be learned by practice of the present general inventive concept.

The foregoing and/or other aspects and utilities of the present general inventive concept can be achieved by providing a fusing device which fuses an image on a printing medium, the fusing device including a belt which is provided to rotate, a heating plate which is supported to an inner surface of the belt, a pressing roller which presses the printing medium against the heating plate, and a piezoelectric member which is disposed to the heating plate to press at least one portion of the heating plate with respect to the pressing roller if power is applied thereto.

The pressing roller may press the belt against the heating plate to form a fusing nip, and the piezoelectric member may press the heating plate with respect to a part, in which a pressing force by means of the pressing roller decreases, of an area in which the fusing nip is formed.

The piezoelectric member may include a support part which is supported to opposite end parts in a lengthwise direction of the heating plate, and a pressing part which extends from the support part to a central portion of the heating plate, and is bent to press the central portion of the heating plate if power is applied thereto.

The fusing device may further include a support plate which is interposed between the piezoelectric member and the heating plate to be attached thereto, and has a bigger Young's modulus than the piezoelectric member.

An upper surface and a lower surface of the piezoelectric member are polarized, and a voltage having the same polarities as the polarized upper and lower surfaces is respectively applied to the upper surface and the lower surface.

The foregoing and/or other aspects and utilities of the present general inventive concept can also be achieved by providing an image forming apparatus, including an image carrying body which is formed with a latent image, a developing device which supplies a developer to the image carrying body to form a visible image, a transferring device which transfers the visible image of the image carrying body on a printing medium, and a fusing device which fuses the visible image on the printing medium.

An upper surface and a lower surface of the piezoelectric member are polarized, and a voltage having the same polarities as the polarized upper and lower surfaces is respectively applied to the upper surface and the lower surface.

The foregoing and/or other aspects and utilities of the present general inventive concept can also be achieved by providing a fusing device which fuses an image on a printing medium, the fusing device including a pressing unit, a plate to form a fusing nip with the pressing unit, and a deformable member disposed on the plate to maintain, control, or adjust the fusing nip between the plate and the pressing unit.

The plate may include a heating plate to generate heat and form the fusing nip with the pressing unit.

The deformable member may include a piezoelectric member.

The deformable member may generate a force to be applied to a portion of the plate to move toward the pressing unit.

The deformable member may control the plate to be deformed with respect to the pressing unit.

The deformable member may generate a force variable according to a distance from the pressing unit.

The fusing device may further include a belt disposed in the fusing nip between the plate and the pressing unit, and the deformable member may be disposed on the plate opposite to the belt.

The plate may include a first surface to face the pressing unit and a second surface on which the deformable member is disposed.

The fusing device may further include a power source to supply a first power to the plate for a first period and a second power to the deformable member for a second period.

The plate may have a first dimension, and the deformable member may have a second dimension.

The fusing device may further include a supporting plate disposed between the plate and the deformable member.

The plate may have a first dimension, the deformable member may have a second dimension, and the supporting plate may have a third dimension.

The foregoing and/or other aspects and utilities of the present general inventive concept can also be achieved by providing an image forming apparatus including an image forming unit to form an image and transfer the image to a printing medium, and a fusing device to fuse the image to the printing medium, and including a pressing unit, a plate to form a fusing nip with the pressing unit, and a deformable member disposed on the plate to maintain, control, or adjust the fusing nip between the plate and the pressing unit belt.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, in which:

FIG. 1 is a side sectional view of a fusing device according to an exemplary embodiment of the present general inventive concept;

FIG. 2 is a front view of the fusing device in FIG. 1;

FIG. 3 is an exemplifying diagram schematically illustrating a stress generating principle of a piezoelectric member;

FIG. 4 is a graph illustrating pressure, a heat transmission and a fusing property in a fusing nip according to existence of a piezoelectric member in a fusing device;

FIG. 5 is a front view illustrating a fusing device according to an exemplary embodiment of the present general inventive concept; and

FIG. 6 is a sectional view illustrating an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

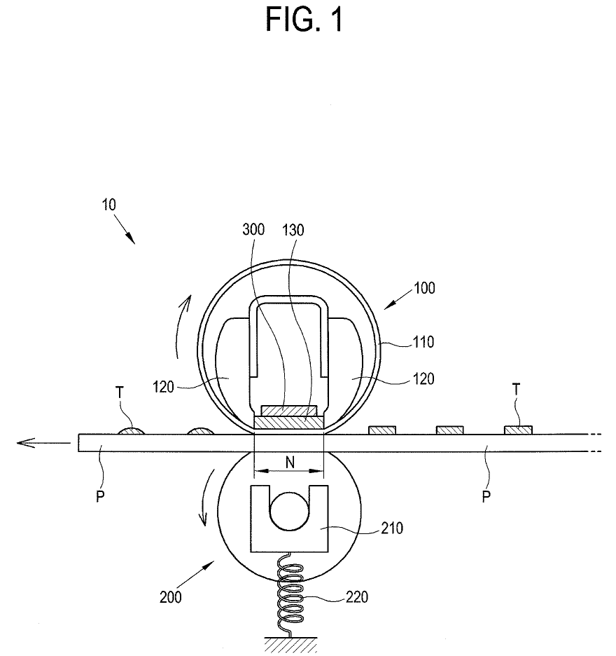

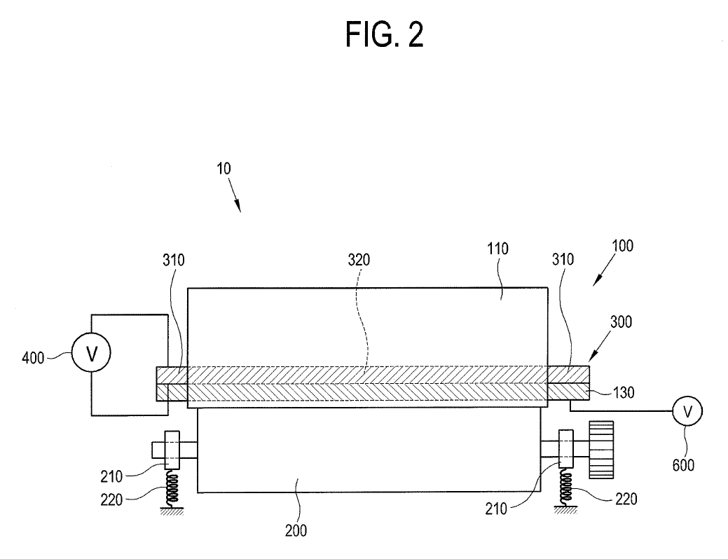

As illustrated in FIGS. 1 and 2, a fusing device 10 according to an exemplary embodiment of the present general inventive concept includes a heating unit 100 to generate and emit heat, and a pressing unit, such as a pressing roller 200, to press a printing medium P against the heating unit 100 and to rotate to fuse a developer T on the printing medium P. A fusing nip N to which heat and pressure are applied is formed between the heating unit 100 and the pressing roller 200 in a widthwise direction of the printing medium P, and the printing medium P passes through the fusing nip N to accomplish fusing. A lengthwise direction of the fusing nip N is parallel with the widthwise direction of the printing medium P. The widthwise direction of the printing medium P and the lengthwise direction of the fusing nip N may be perpendicular to a feeding direction of the printing medium P. When the fusing nip N may be extended in a direction parallel to the feeding direction, an area is formed as the fusing nip N with a pressing unit, such as the pressing roller 200, in the widthwise direction and the feeding direction of the printing medium P or the lengthwise direction and a widthwise direction of the fusing nip N.

Here, an area in which the fusing nip N is formed may include an area in which a pressing force by means of the pressing roller 200 decreases. That is, the fusing nip N is not uniform between the heating unit 100 and the pressing roller 200, and the pressing force is not equally distributed throughout the fusing nip-N. The fusing device 10 includes a piezoelectric member 300 disposed to the heating unit 100 to press the heating unit 100 against the pressing roller 200.

The heating unit 100 emits the heat to fuse the developer T on the printing medium P. The heating unit 100 contacts to a first surface of the printing medium P on which the developer T is seated, and the pressing roller 200 presses a second surface of the printing medium P against the heating unit 100 so that the heat from the heating unit 100 can be transmitted to the printing medium P. That is, the heating unit 100 applies the heat for the fusing to the fusing nip N through which the printing medium P passes.

The heating unit 100 may have various configurations. The heating unit 100 according to the present exemplary embodiment includes a belt 110 disposed to rotate and to pass through the fusing nip N, a guide member 120 to rotatably support the belt 110, and a plate, such as a heating plate 130, supported in an inner surface of the belt 110 to form the fusing nip N with the pressing unit, i.e., the pressing roller 200.

An outer surface of the belt 110 contacts a surface of the printing medium P, and the guide member 120 and the heating plate 130 are disposed on an inner surface of the belt 110. The belt 110 includes a flexible film extending in the widthwise direction of the printing medium P and extending in the feeding direction so that the opposite end parts thereof can be attached to each other, and rotates along a proceeding or feeding direction of the printing medium P.

The belt 110 may not include a separate driving device for rotating, and rotates by a rotating force of the pressing roller 200. Here, since the belt 110 is supported to the guide member 120, the belt 110 forms the fusing nip N together with the pressing roller 200 without deviating from the position thereof.

Since the belt 110 rotates and is heated by the heat from the heating plate 130, the belt 110 is formed of a material having abrasion and deterioration characteristics against heat and friction.

The guide member 120 extends in the widthwise direction of the printing medium P, and prevents the belt 100 from deviating from an initial position. The guide member 120 supports the inner surface of the belt 110 so that the belt 110 can rotate. Since the inner surface of the belt 110 rotates with respect to the guide member 120, an outer shape of the guide member 120 contacting to the belt 110 may be rounded.

The heating plate 130 emits the heat for the fusing operation, and is supported to the inner surface of the belt 110 contacting to the pressing roller 200. The heating plate 130 is elongated in the widthwise direction of the printing medium P, and a lower surface thereof contacts the inner surface of the belt 110 pressed by the pressing roller 200. Accordingly, the heat emitted from the heating plate 130 is transmitted to the belt 110 from the lower surface of the heating plate 130 and then transmitted to the fusing nip N.

The heating plate 130 may have various configurations to generate and emit heat. For example, an electric heating wire having a high resistance is disposed inside the heating plate 130 in a lattice shape, and power is supplied from a power source 600 to the electric heating wire so that the heating plate 130 can emit the heat.

The pressing roller 200 presses the printing medium P toward the heating unit 100, and rotates. The pressing roller 200 has a roller shape extending in the widthwise direction of the printing medium P, and rotates by means of a driving force transmitted from a driving source (not illustrated). The pressing roller 200 includes a bushing 210 to support opposites end parts thereof, and an elastic member 220 to elastically press a pair of bushings 210 toward the heating plate 130.

The pressing roller 200 is pressed by a pressing force of the elastic member 220 against the lower surface of the heating plate 130. Here, the belt 110 is interposed between the pressing roller 200 and the heating plate 130. Accordingly, the fusing nip N is formed between the pressing roller 200 and the outer surface of the belt 110 pressed by means of the pressing roller 200 against the heating plate 130, and the heat from the heating plate 130 and the pressure by the pressing roller 200 are concurrently applied to the fusing nip N.

However, the elastic member 220 pressing the pressing roller 200 presses the opposite end parts in a lengthwise direction of the pressing roller 220. Accordingly, an elastic pressing force of the elastic member 220 decreases due to a self weight of the pressing roller 200 as it becomes more distanced from the opposite end parts of the pressing roller 200 pressed by the elastic member 220, that is, nearer to a central portion of the pressing roller 200. This pressure applied from the pressing roller 200 to the belt 110 or the heating plate 130 decreases along the width of the fusing nip N contacting to the printing medium P in the central portion of the pressing roller 200, and thus, an amount of heat transmitted to the developer T is reduced. This phenomenon is aggravated as the length of the pressing roller 200 increases.

Here, the central portion of the pressing roller 200 refers to a central portion in the lengthwise direction of the pressing roller 200, that is, a portion between the opposite end parts in the lengthwise direction of the pressing roller 200 pressed by the elastic member 220.

If the elastic pressing force of the elastic member 220 increases to correct the pressure decrease in the central portion of the pressing roller 200, the fusing in a portion adjacent to the opposite end parts of the pressing roller 200 pressed by the elastic member 220 is excessively performed so that the developer T can be squashed on the printing medium P, or the printing medium P can be attached to the belt 110. Accordingly, a configuration for minimizing the pressure decrease in the central portion of the pressing roller 200 without increasing the elastic pressing force of the elastic member 220 is needed. For this, a deformable member, such as a piezoelectric member 300, is disposed on the heating plate 130.

The piezoelectric member 300 has a plate shape extending in the widthwise direction of the printing medium P. The piezoelectric member 300 is disposed to contact the upper surface of the heating plate 130, and presses at least one portion of the heating plate 130 against the pressing roller 200 if power is applied thereto by a power applying unit 400. In detail, the piezoelectric member 300 presses the heating plate 130 against a part, in which the pressing force by the pressing roller 200 decreases, of an area in which the fusing nip N is formed.

The power applying unit 400 and the power source 600 may be a single power source to supply a first voltage to the piezoelectric member 300 and a second voltage to the heating plate 130. The first voltage is supplied to the piezoelectric member 300 according to a first driving period, and the second voltage is supplied to the heating plate 130 according to a second driving period. The first period is referred to as a period to generate deformation of the piezoelectric member 300, and the second period is referred to as a period to generate a fusing force to fuse the image on the printing medium in a fusing operation.

The piezoelectric member 300 includes a support part 310 to be supported at the opposite end parts in a lengthwise direction of the heating plate 130, and a pressing part 320 disposed between the opposite end parts of the support part 310, extended to the central portion of the heating plate 130 from the support part 310, and to be bent if the power is applied thereto to press the central portion of the heating plate 130 toward the pressing roller 200. The pressing part 320 according to the present exemplary embodiment is the substantially same as the central area in a lengthwise direction of the piezoelectric member 300. Alternatively, a total surface of the piezoelectric member 300 may be attached to the heating plate 130. Here, the central portion of the heating plate 130 as a central portion with respect to the lengthwise direction refers to a portion corresponding to the central portion of the pressing roller 200.

A voltage is generated if pressure is applied to the piezoelectric member 300, and transformation is caused if the voltage is applied thereto. For this, the piezoelectric member 300 may be formed of various materials. For example, the piezoelectric member 300 may include a piezoelectric ceramic material named as ‘PZT’. The PZT is a compound of lead, zirconium and titanium with a specific ratio, and has a composition of [Pb(Zr,Ti)O₃].

According to the present embodiment, the heating plate 130 may be an element to generate heat to the printing medium P, and/or another element to form the fusing nip N with the pressing roller 200. When the heat is generated from a portion of the guide member 120 or an external heating member connected to the power source 600, and when the heat is transferred to the printing medium through the belt 110, the heating plate 130 may not generate heat and may be referred to as the another element to form the fusing nip N. In this case, the piezoelectric member 300 is disposed on the another element of the heating plate 130 to compensate for an non-uniform distance between the heating plate 130 and the pressing roller 200 in the fusing nip N.

The piezoelectric member 300 may have a dimension with a thickness, a length in a direction parallel to the feeding direction of the printing medium P, and a width in the widthwise direction of the printing medium P. The dimension of the piezoelectric member 300 can be determined to maintain a desired level of the distance in the widthwise direction and/or the feeding direction between the heating plate 130 and the pressing roller 200 in the fusing nip N. The thickness of the piezoelectric member 300 may be the same as or different from a thickness of the heading plate 130. The thickness of the piezoelectric member 300 may vary along the widthwise direction of the printing medium P, so that a variable force is applied to the heating plate 130 according to a distance from an end portion or a central portion of the heating plate 130. The length and the width of the piezoelectric member 300 may be the same as or different from a length and a width of the heating plate 130. The piezoelectric member 300 may be disposed on a portion of the heating plate to apply a predetermined force to a corresponding portion of the heating plate 130 when the predetermined force is enough to maintain the fusing nip N.

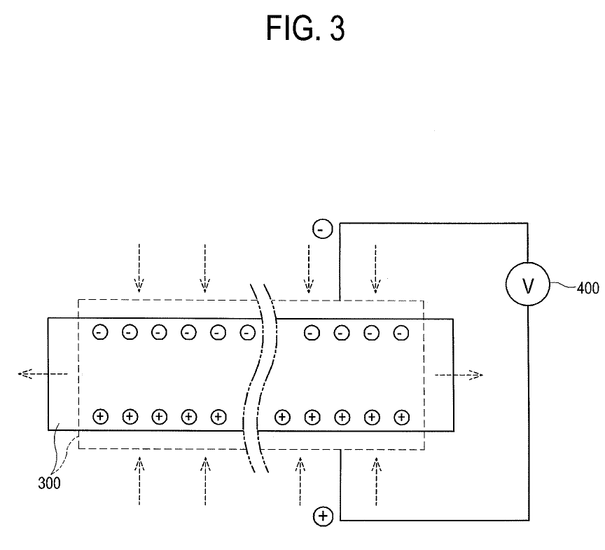

Hereinafter, a principle in which the piezoelectric member 300 is bent as the power is applied thereto will be described by referring to FIG. 3.

The piezoelectric member 300 has a spontaneous polarization polarized in a plus polarity (i.e., first polarity) and a minus polarity (i.e., second polarity opposite to the first polarity) in an initial state in which the power is not applied thereto. As illustrated in FIG. 3, it is assumed that an upper surface of the piezoelectric member 300 is spontaneously polarized in the minus polarity, and a lower surface of the piezoelectric member 300 is spontaneously polarized in the plus polarity. Here, the power applying unit 400 applies the voltage to the upper surface and the lower surface of the piezoelectric member 300.

The power applying unit 400 may apply the voltage having the same polarity as the spontaneous polarization to the upper surface and the lower surface of the piezoelectric member 300, respectively. As illustrated in FIG. 3, the power applying unit 400 applies the minus polarity to the upper surface of the piezoelectric member 300, and applies the plus polarity to the lower surface thereof. Accordingly, pressure is generated in the upper surface and the lower surface of the piezoelectric member 300 due to an electromagnetic action between the polarity applied from the power applying unit 400 and the spontaneous polarity. This pressure acts as a transforming force contracting the piezoelectric member 300 in a thickness direction, and concurrently, elongating the piezoelectric member 300 in a lengthwise direction.

Here, since the support part 310 is supported to the heating plate 130, the pressing part 320 is bent as the piezoelectric member 300 is transformed in the lengthwise direction. Accordingly, if a bending direction of the pressing part 320 is toward the heating plate 130, the heating plate 130 can press the inner surface of the belt 110 to the pressing roller 200.

Accordingly, if the power is applied to the piezoelectric member 300, the piezoelectric member 300 can press a predetermined portion of the heating plate 130 to the pressing roller 200. The polarity of the voltage applied to the opposite surfaces of the piezoelectric member 300 by the power applying unit 400 is determined according to a spontaneous polarizing property and a bending direction of the piezoelectric member 300.

Hereinafter, in the fusing device 10 according to the exemplary embodiment of the present general inventive concept, a pressure correcting method in the central area of the fusing nip N in which the pressing force by means of the pressing roller 200 decreases will be described by referring to FIGS. 1 to 4.

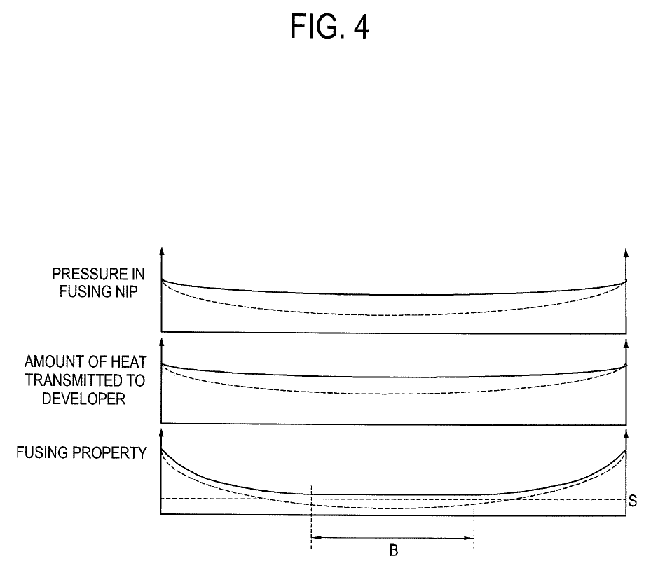

At first, a graph of FIG. 4 illustrates a pressure, a heat transmission and a fusing property in a fusing nip under a condition that the piezoelectric member 300 is disposed and under another condition that the piezoelectric member 300 is not disposed. A horizontal axis of the graph represents a lengthwise direction position of the fusing nip N, the heating plate 130 or the pressing roller 200. For example, the opposite end parts of the horizontal axis corresponds to the end parts of the fusing nip N, and a central area of the horizontal axis corresponds to the central area of the fusing nip N. In FIG. 4, a dotted line represents a state that the piezoelectric member 300 is not disposed, and a solid line represents a state that the piezoelectric member 300 is disposed.

If the printing medium P formed with a visible image not being fused yet is transported to the fusing device 10, the pressing roller 200 starts rotating. The pressing roller 200 contacts to the lower surface of the heating plate 130 to interpose the belt 110 therebetween, and the belt 110 is driven by the pressing roller 200 to rotate. Accordingly, the fusing nip N is formed between the belt 110 and the pressing roller 200.

While the printing medium P passes through the fusing nip N, the printing medium P is pressed against the heating plate 130 by means of the pressing roller 200 to interpose the belt 110 therebetween. The heat of the heating plate 130 is transmitted to the belt 110, and the developer T is fused to the printing medium P by means of the heat and the pressure applied to the fusing nip N.

Here, since the pressing roller 200 is pressed by the elastic member 220 disposed to the opposite end parts thereof, the pressing force in the central portion of the pressing roller 200 relatively decreases according to a distance from the opposite end parts.

Accordingly, as illustrated in FIG. 4, if the fusing nip N is formed in the lengthwise direction of the pressing roller 200, the pressure applied by means of the pressing roller 200 more decreases in the central area of the fusing nip N than in the opposite end parts of the fusing nip N, and the width of the fusing nip N relatively decreases. This means that the amount of heat transmitted from the heating plate 130 to the developer T decreases in the central area of the fusing nip N.

Due to these factors, a fusing property becomes deteriorated from the end parts of the fusing nip N to the central area thereof.

An experiment about the fusing property may be performed with various methods. For example, the developer T is transferred on the printing medium P in a predetermined pattern, and then the printing medium P passes through the fusing device 10 to perform a fusing process. Then, the developer T is determined whether to be fused on the printing medium P or not. If more than 90% of the developer T is fused on a predetermined unit area of the printing medium P, the fusing property in the unit area is determined to be good. This experiment is exemplarily described, and does not define the principles and spirit of the present invention.

In FIG. 4, when the piezoelectric member 300 is not employed, the central area B of the fusing nip N is illustrated as an inferior section having the fusing property under reference S with which the fusing property is determined to be good. For example, in the central area B of the fusing nip N, the fusing of the developer T with respect to the printing medium P is incapable of being accomplished more than 90%. This is caused due to the above factors.

The piezoelectric member 300 is employed to solve this fusing property inferiority generated in the central area of the fusing nip N. If the power is applied to the piezoelectric member 300 from the power applying unit 400, the central area thereof is bent, and the bent area presses the central portion of the heating plate 130 toward the fusing nip N. Accordingly, the pressure by means of the piezoelectric member 300 can be applied to the central area of the fusing nip N in which the pressing force of the pressing roller 200 decreases. Result according to this is illustrated as the solid line in FIG. 4.

If the case that the piezoelectric member 300 is employed is compared with the case that the piezoelectric member 300 is not employed, as illustrated in FIG. 4, the pressure applied to the central area B of the fusing nip N, and the amount of heat transmitted to the developer T increase. In this area, the pressing force by means of the piezoelectric member 300 is added to the elastic pressing force by means of the pressing roller 200. Accordingly, the fusing property of the developer T in the central area B of the fusing nip N can satisfy the reference S which is for determining the fusing property to be good.

As described above, the piezoelectric member 300 is disposed to the heating plate 130 so that the pressing force can be added with respect to the pressure decrease area of the fusing nip N, thereby minimizing a pressure inequality applied to the fusing nip N.

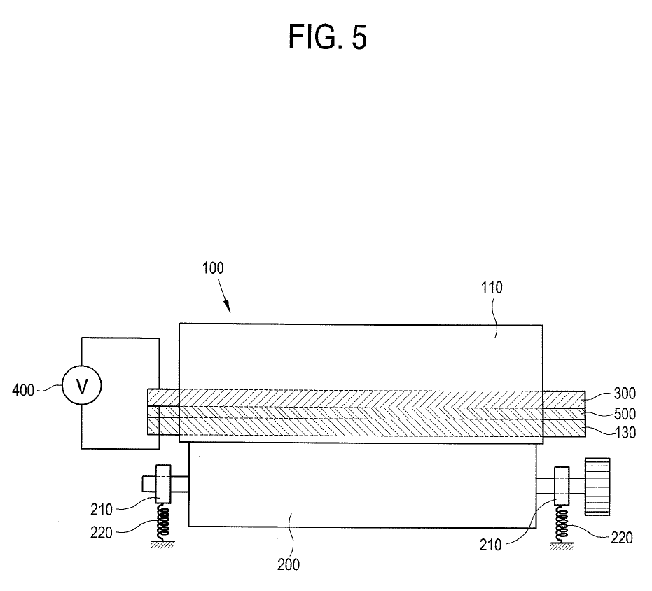

Compared with the exemplary embodiment of FIGS. 1-2, the pressing force against the fusing nip N may increase by increasing a bending coefficient of the piezoelectric member 300. Hereinafter, an exemplary embodiment of the present invention with this configuration will be described by referring to FIG. 5.

As illustrated in FIGS. 1-5, a fusing device 10 according to an exemplary embodiment of the present general inventive concept further includes a support plate 500 interposed between a piezoelectric member 300 and a heating plate 130 to be attached thereto.

The support plate 500 is interposed between the piezoelectric member 300 and the heating plate 130, and is attached and supported to the piezoelectric member 300 and the heating plate 130. The support plate 500 may be provided to be attached and supported to a total surface of the piezoelectric member 300 and the heating plate 130, or to only the opposite end parts in a lengthwise direction like the exemplary embodiment of FIGS. 1 and 2.

The support plate 500 may be formed of various materials, Young's modulus of which is bigger than that of the piezoelectric member 300.

The Young's modulus means the ratio of stress and strain, in detail, the ratio of tension applied per unit area and length elongated per unit length. That the Young's modulus of the support plate 500 is bigger than that of the piezoelectric member 300 means that the supporting plate 500 has a bigger stiffness representing a resisting degree to an external force than the piezoelectric member 300.

If power is applied to the piezoelectric member 300, the piezoelectric member 300 starts bending. Here, since the support plate 500 attaching to the piezoelectric member 300 has a bigger stiffness than the piezoelectric member 300, a bending coefficient increases in comparison with the case that there is no support plate 500. Accordingly, a pressing force against the heating plate 130 can increase in comparison with the first exemplary embodiment.

As describe above, the support plate 500 having a bigger Young's modulus than the piezoelectric member 300 is interposed between the piezoelectric member 300 and the heating plate 130 to increase the pressing force against the heating plate 130.

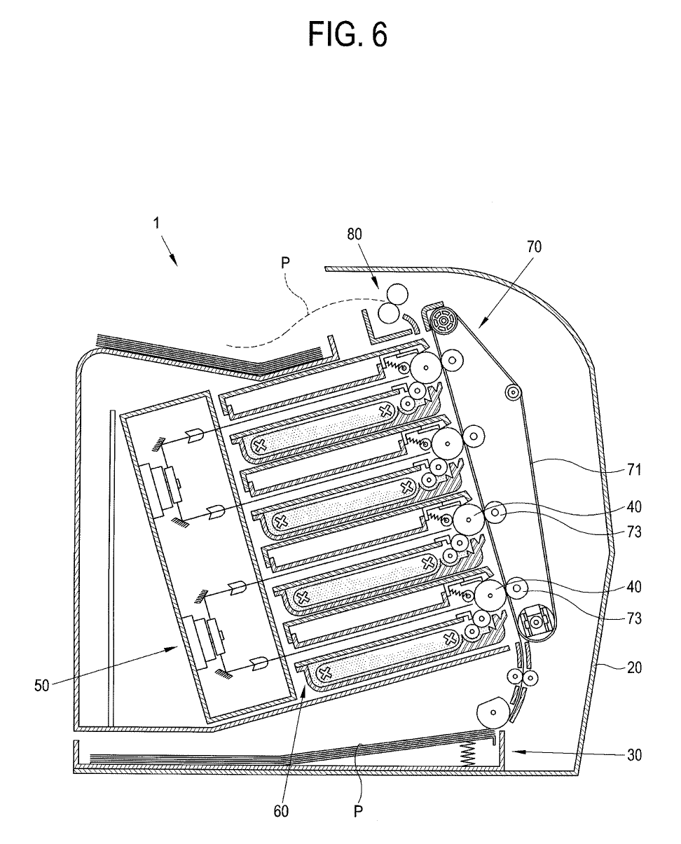

FIG. 6 is a sectional view illustrating an image forming apparatus 1 according to an exemplary embodiment of the present general inventive concept. Referring to FIG. 6, the image forming apparatus 1 according to the exemplary embodiment of the present general inventive concept includes a main body casing 20, a medium supplying device 30 to load and supply a printing medium P, a plurality of image carrying bodies 40 formed with an electrostatic latent image and a visible image by means of a developer, a light scanning device 50 to form the electrostatic latent image on the image carrying bodies 40, a developing device 60 to supply the developer to the image carrying bodies 40, a transferring device 70 to transfer the visible image of the image carrying bodies 40 to the printing medium P, and a fusing device 80 to fuse the transferred visible image being not fused yet on the printing medium P.

At least one of the plurality of image carrying bodies 40, the light scanning device 50, and the developing device 60 may be referred to as an image forming unit to form an image on the printing medium P. The transferring device 70 transfers the printing medium P with the image to the fusing device 80, so that the fusing device 80 fuses the image to the printing medium P.

The image carrying body 40 includes a plurality of bodies, for example, four bodies corresponding to yellow, magenta, cyan and black disposed along a transportation path of the printing medium P in sequence to form a color image on the printing medium P. After an outer surface of the image carrying body 40 is charged to be uniform, an electric potential difference is generated by means of a beam from the light scanning device 50 to from the electrostatic latent image. If the developer is supplied from the developing device 60 to the image carrying body 40 formed with the electrostatic latent image, the visible image by means of the developer is formed on the image carrying body 40.

The light scanning device 50 respectively scans the beam to the plurality of image carrying bodies 40 to form the electrostatic latent image. The light scanning device 50 divides an image information of the color image to be finally formed by each color, and forms the electrostatic latent image on the respective image carrying bodies 40 based on this.

The developing device 60 is provided to correspond to the plurality of image carrying bodies 40 provided by each color developer. Accordingly, the visible image having different colors can be formed on the respective image carrying bodies 40.

The transferring device 70 transports the printing medium P to pass through the plurality of image carrying bodies 40 in sequence, and transfers and overlays the visible image of the respective image carrying bodies 40 on the printing medium P. For this, the transferring device 70 includes a transferring backup belt 71, and a transferring roller 73 facing the respective image carrying bodies 40. The printing medium P is transported along the transferring backup belt 71, and the visible image of the image carrying body 40 is transferred on the printing medium P by means of a transferring bias applied to the transferring roller 73.

The fusing device 80 applies heat and pressure to the printing medium P to which the visible image is transferred by the transferring device 70 to fuse the visible image. The fusing device 80 may have the substantially same configuration as the fusing device 10 according to the exemplary embodiment described above.

Although FIG. 6 illustrates the image forming apparatus 1 with the plurality of image carrying bodies 40, the light scanning device 50, and the developing device 60, the present general inventive concept is not limited thereto. The image forming apparatus 1 may include an image carrying body, a light scanning device, and a developing device to form an image. Also, the image forming apparatus 1 may not include the transferring unit 70. It is possible that a conventional image forming unit and/or a conventional transferring unit can be used in the image forming apparatus 1.

As described above, the present general inventive concept provides a fusing device and an image forming apparatus having the same adding a pressing force to an area in which pressure decreases among an area in which a fusing nip is formed to minimize an unequal distribution of pressure applied to the fusing nip, thereby improving a fusing property of a developer and quality of an image on a printing medium. Accordingly, reliability of a product can be improved.

Also, the present general inventive concept provides a fusing device and an image forming apparatus having the same minimizing a partial abrasion of a pressing roller, a belt, etc., thereby prolonging a lifespan of a product. Accordingly, a maintenance cost of the product can be reduced.

Although a few embodiments of the present general inventive concept have been shown and described, it will be appreciated by those skilled in the art that changes may be made in these embodiments without departing from the principles and spirit of the general inventive concept, the scope of which is defined in the

What is claimed is:

1. A fusing device which fuses an image on a printing medium, the fusing device comprising:
a belt which is provided to rotate;
a heating plate which is supported to an inner surface of the belt;
a pressing roller which presses the printing medium against the heating plate; and
a piezoelectric member which is disposed on the heating plate to press at least one portion of the heating plate with respect to the pressing roller if power is applied thereto.

2. The fusing device of claim 1, wherein:
the pressing roller presses the belt against the heating plate to form a fusing nip; and
the piezoelectric member presses the heating plate with respect to a part, in which a pressing force of the pressing roller decreases, in which the fusing nip is formed.

3. The fusing device of claim 1, wherein the piezoelectric member comprises:
a support part which is supported to opposite end parts in a lengthwise direction of the heating plate, and
a pressing part which extends from the support part to a central portion of the heating plate, and is bent to press the central portion of the heating plate if power is applied thereto.

4. The fusing device of claim 3, further comprising:
a support plate which is interposed between the piezoelectric member and the heating plate to be attached thereto, and has a Young's modulus greater than that of the piezoelectric member.

5. The fusing device of claim 1, wherein:
an upper surface and a lower surface of the piezoelectric member are polarized; and
a voltage having the same polarities as the polarized upper and lower surfaces is respectively applied to the upper surface and the lower surface.

6. An image forming apparatus, comprising:
an image carrying body which is formed with a latent image;
a developing device which supplies a developer to the image carrying body to form a visible image;
a transferring device which transfers the visible image of the image carrying body on a printing medium; and
a fusing device which fuses the visible image on the printing medium, and comprising:
a belt which is provided to rotate,
a heating plate which is supported to an inner surface of the belt;
a pressing roller which presses the printing medium against the heating plate; and
a piezoelectric member which is disposed on the heating plate to press at least one portion of the heating plate with respect to the pressing roller if power is applied thereto.

7. The image forming apparatus of claim 6, wherein:
an upper surface and a lower surface of the piezoelectric member are polarized; and
a voltage having the same polarities as the polarized upper and lower surfaces is respectively applied to the upper surface and the lower surface.

8. A fusing device which fuses an image on a printing medium, the fusing device comprising:
a pressing unit;
a plate to form a fusing nip with the pressing unit; and
a deformable member disposed on the plate to control the fusing nip between the plate and the pressing unit.

9. The fusing device of claim 8, wherein the plate comprises a heating plate to generate heat and form the fusing nip with the pressing unit.

10. The fusing device of claim 8, wherein the deformable member comprises a piezoelectric member.

11. The fusing device of claim 8, wherein the deformable member generates a force to be applied to a portion of the plate to move toward the pressing unit.

12. The fusing device of claim 8, wherein the deformable member controls the plate to be deformed with respect to the pressing unit.

13. The fusing device of claim 8, wherein the deformable member generate a force variable according to a distance from the pressing unit.

14. The fusing device of claim 8, further comprising:
a belt disposed in the fusing nip between the plate and the pressing unit,
wherein the deformable member is disposed on the plate opposite to the belt.

15. The fusing device of claim 8, further comprising:
a supporting plate disposed between the plate and the deformable member.

16. An image forming apparatus comprising:
an image forming unit to form an image and transfer the image to a printing medium; and
a fusing device to fuse the image to the printing medium, and comprising:
a pressing unit;
a plate to form a fusing nip with the pressing unit; and
a deformable member disposed on the plate to control the fusing nip between the plate and the pressing unit belt.
